(19) United States
(12) Patent Application Publication
(10) Pub. No.: US 2024/0300601 A1
(43) Pub. Date: Sep. 12, 2024

(54) Motorcycle Floor Mat And Motorcycle

(71) Applicant: DARWIN PRECISIONS CORPORATION, Hsinchu County (TW)

(72) Inventors: TZU-HSUAN PENG, Hsinchu County (TW); CHIA HSIN CHANG, Hsinchu County (TW); Hsiu-Chen Sun, Hsinchu County (TW)

(21) Appl. No.: 18/222,491

(22) Filed: Jul. 17, 2023

(30) Foreign Application Priority Data
Mar. 8, 2023 (TW) 112108527

(51) Int. Cl. B62J 7/08

(52) U.S. Cl. CPC B62J 7/08

(57) ABSTRACT

The present invention provides a motorcycle floor mat including a base and a telescopic bracket. The base is adapted to be placed on a foot pedal and has a receiving groove. The telescopic bracket is arranged in the receiving groove and adapted to extend from the receiving groove, and a storage space is formed between the telescopic bracket and the base. The present invention further provides a motorcycle including the above telescopic bracket.

### CROSS-REFERENCE TO RELATED APPLICATION

This application claims the priority benefit of Taiwan Application No. 112108527, filed on Mar. 8, 2023. The entirety of the above-mentioned patent application is hereby incorporated by reference herein and made a part of this specification.

### FIELD OF THE INVENTION

The present invention relates to a motorcycle floor mat and a motorcycle, and more particularly to a motorcycle floor mat and a motorcycle with a telescopic bracket.

### BACKGROUND OF THE INVENTION

In Taiwan, it is quite popular for people to use motorcycles for commuting or daily transportation. However, due to a limited carrying space of a motorcycle, if a rear compartment of the motorcycle cannot meet the requirement for carrying an item, the carried item will be placed on a foot pedal of the motorcycle instead. During riding of the motorcycle, there is a risk for the carried item to fall off the foot pedal of the motorcycle. When the carried item falls off, in addition to possible damage of the carried item, it is more likely to cause a traffic accident, so it is necessary to take precautions.

### SUMMARY OF THE INVENTION

The present invention provides a motorcycle floor mat, which is adapted to be placed on a foot pedal of a motorcycle, to prevent a carried item from falling.

The present invention further provides a motorcycle, to prevent the carried item from falling.

The motorcycle floor mat provided by the present invention includes a base and a telescopic bracket. The base is adapted to be placed on a foot pedal and has a receiving groove. The telescopic bracket is arranged in the receiving groove and adapted to extend from the receiving groove, and a storage space is formed between the telescopic bracket and the base.

In an embodiment of the present invention, the above base has a first surface and a second surface opposite to each other, the second surface is adapted to be connected to the foot pedal, the receiving groove is arranged on the first surface, and when the telescopic bracket is received in the receiving groove, the telescopic bracket does not protrude from the first surface.

In an embodiment of the present invention, the above base further has a gripping recess arranged on the first surface and adjacent to the receiving groove.

In an embodiment of the present invention, the above telescopic bracket includes a telescopic cylinder.

In an embodiment of the present invention, the above telescopic cylinder includes multiple annular portions, the annular portions are sequentially connected when the telescopic cylinder is in an extended state, and the closer the annular portions are to a bottom of the receiving groove, the smaller the opening areas of the annular portions are.

In an embodiment of the present invention, the above telescopic bracket includes a first telescopic portion and a second telescopic portion arranged opposite to each other, and the receiving groove includes a first receiving portion and a second receiving portion adapted to receive the first telescopic portion and the second telescopic portion, respectively.

In an embodiment of the present invention, the above base has a first side surface and a second side surface opposite to each other, an extension direction of the first side surface and the second side surface is a direction from a front of a motorcycle to a rear of the motorcycle, and the first telescopic portion and the second telescopic portion are arranged along the first side surface and the second side surface, respectively.

In an embodiment of the present invention, each of the above first telescopic portion and second telescopic portion includes a connecting rod mechanism.

In an embodiment of the present invention, the above telescopic bracket further includes a connecting piece for connecting the first telescopic portion to the second telescopic portion, and the receiving groove further includes a third receiving portion adapted to receive the connecting piece.

In an embodiment of the present invention, each of the above first telescopic portion and second telescopic portion includes multiple telescopic rods.

In an embodiment of the present invention, the above base further has a fixed connection portion adapted to be fixedly connected to the foot pedal.

The present invention further provides a motorcycle, including a housing and a telescopic bracket. The housing includes a foot pedal, the foot pedal has a receiving groove, and the telescopic bracket is arranged in the receiving groove and adapted to extend from the receiving groove, so as to form a storage space between the telescopic bracket and the foot pedal.

The motorcycle floor mat and the motorcycle according to the present invention have the telescopic bracket, so that when the carried item is placed on the foot pedal of the motorcycle, the telescopic bracket may be extended out to prevent the item from falling, and when there is no need to carry the item, the telescopic bracket may be retracted to avoid occupying a foot placement space for a rider.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram that a motorcycle floor mat is placed on a motorcycle according to an embodiment of the present invention;

FIG. 2 is a schematic diagram that a telescopic bracket of a motorcycle floor mat extends from a receiving groove according to an embodiment of the present invention;

FIG. 3 is a schematic diagram that the telescopic bracket of the motorcycle floor mat is received in the receiving groove in FIG. 2;

FIG. 4 is a schematic diagram that a telescopic bracket of a motorcycle floor mat extends from a receiving groove according to another embodiment of the present invention;

FIG. 5 is a schematic diagram that a telescopic bracket of a motorcycle floor mat extends from a receiving groove according to another embodiment of the present invention;

FIG. 6 is a schematic diagram that a telescopic bracket of a motorcycle floor mat extends from a receiving groove according to another embodiment of the present invention;

FIG. 7 is a schematic diagram of a motorcycle floor mat according to another embodiment of the present invention; and

FIG. 8 is a schematic diagram of a motorcycle according to another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The above and other technical contents, features and effects of the present invention will be clearly presented in the detailed description of a preferred embodiment below in conjunction with the reference drawings. The directional term mentioned in the embodiment below, such as up, down, left, right, front, or back, is only the direction with reference to the accompanying drawings. Therefore, the directional terms used are used to explain rather than to limit the present invention.

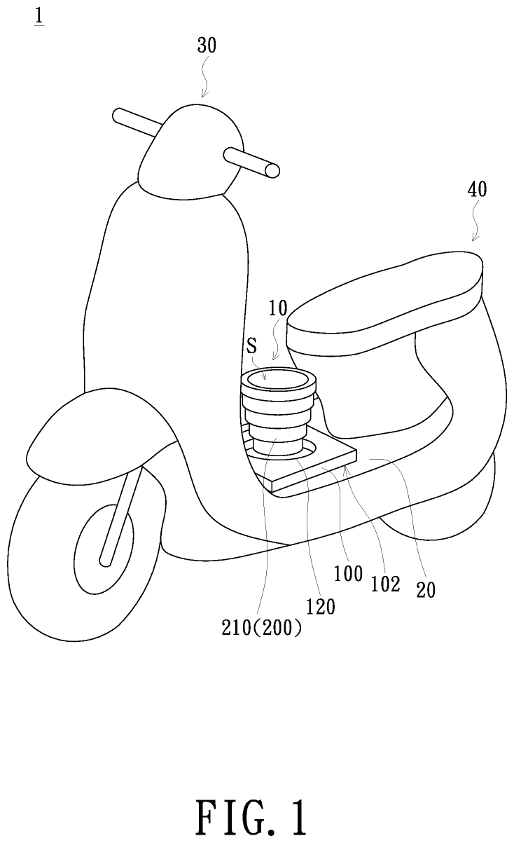

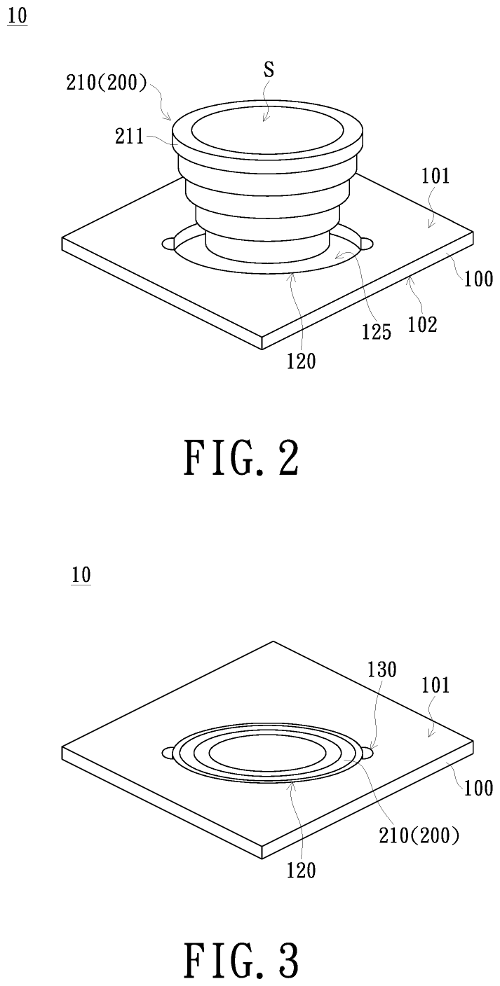

FIG. 1 is a schematic diagram that a motorcycle floor mat is placed on a motorcycle according to an embodiment of the present invention. FIG. 2 is a schematic diagram that a telescopic bracket of a motorcycle floor mat extends from a receiving groove according to an embodiment of the present invention. Referring to FIG. 1 and FIG. 2, a motorcycle floor mat 10 of this embodiment is adapted to be placed on a foot pedal 20 of a motorcycle 1, and the motorcycle floor mat 10 includes a base 100 and a telescopic bracket 200. The base 100 is adapted to be placed on the foot pedal 20 and has a receiving groove 120. The base 100 has, for example, a first surface 101 and a second surface 102 opposite to each other, the second surface 102 is, for example, adapted to be connected to the foot pedal 20, and the receiving groove 120 is, for example, arranged on the first surface 101. The telescopic bracket 200 is arranged in the receiving groove 120 and adapted to extend from the receiving groove 120, so that a storage space S is formed between the telescopic bracket 200 and the base 100. The storage space S may be, for example, provided for placing a carried item.

The telescopic bracket 200 of this embodiment includes, for example, a telescopic cylinder 210. The telescopic cylinder 210 includes multiple annular portions 211, the annular portions 211 are sequentially connected when the telescopic cylinder 210 is in an extended state, and the closer the annular portions 211 are to a bottom 125 of the receiving groove 120, the smaller the opening areas of the annular portions are. In other words, in the annular portions 211 of the telescopic cylinder 210, the annular portions 211 further away from the bottom 125 of the receiving groove 120 have larger opening areas, making it easy for a user to take or place the item in the storage space S. Moreover, due to small opening areas of the annular portions 211 close to the bottom 125 of the receiving groove, the user may be provided with a larger foot placement space.

In addition, the number of the annular portions 211 of the telescopic cylinder 210 during stretching may also be adjusted according to the usage requirement, so as to adjust a height of the telescopic cylinder 210. For example, if the placed item is shorter, only the two annular portions 211 may be extended from the receiving groove 120, and if the placed item is longer, all the annular portions 211 may be extended out (as shown in FIG. 2), so that when placed in the storage space S, the item can be blocked by the telescopic cylinder 210 to be prevented from falling. When the telescopic cylinder 210 of this embodiment is in the extended state, the closer the annular portions 211 are to the bottom 125 of the receiving groove 120, the smaller the opening areas of the annular portions are. However, the opening areas of the annular portions 211 are not specifically limited in the present invention. In another embodiment, for example, in the annular portions 211, the opening areas of the annular portions 211 in the middle may be larger than the opening areas of the annular portions away from the bottom 125 of the receiving groove and the opening areas of the annular portions close to the bottom 125 of the receiving groove. In addition, a shape of the telescopic cylinder 210 of this embodiment may be, for example, a circle, but may also be other shape, such as a square and an ellipse. The shape of the telescopic cylinder 210 is not specifically limited in the present invention. The telescopic cylinder 210 in this embodiment has, for example, five annular portions 211, but the quantity of annular portions 211 of the telescopic cylinder 210 is not specifically limited in the present invention.

A material of the telescopic cylinder 210 in this embodiment is, for example, an elastic material, such as silica gel or rubber, making it easy to stretch. However, the material of the telescopic cylinder 210 is not specifically limited in the present invention. In another embodiment of the present invention, the material of the telescopic cylinder 210 is, for example, metal.

FIG. 3 is a schematic diagram that the telescopic bracket of the motorcycle floor mat is received in the receiving groove in FIG. 2. Referring to FIG. 3, when the telescopic bracket 200 is received in the receiving groove 120, the telescopic bracket 200 does not, for example, protrude from the first surface 101. Specifically, by taking the telescopic cylinder 210 of the telescopic bracket 200 as an example, when the telescopic cylinder 210 is received in the receiving groove 120, the telescopic cylinder 210 is, for example, flush with the first surface 101 of the base 100, allowing the feet of the user to be placed stably on the motorcycle floor mat 10. However, this is not specifically limited in the present invention. In another embodiment of the present invention, the telescopic bracket 200 may also be lower than the first surface 101 of the base 100 when received in the receiving groove 120.

In addition, the base 100 in this embodiment further includes, for example, a gripping recess 130 that is arranged on the first surface 101 and is, for example, adjacent to the receiving groove 120. Specifically, the design of the gripping recess 130 makes it easy for the user to grip the telescopic cylinder 210 and stretch it upwards when the telescopic bracket 200 such as the telescopic cylinder 210 is received in the receiving groove 120. The base 100 in this embodiment has, for example, two gripping recesses 130 symmetrically arranged on an outer circumference of the receiving groove 120. However, the quantity and arrangement positions of gripping recesses 130 are not specifically limited in the present invention. In another embodiment of the present invention, the base 100 of the motorcycle floor mat 10 is, for example, not provided with the gripping recess 130.

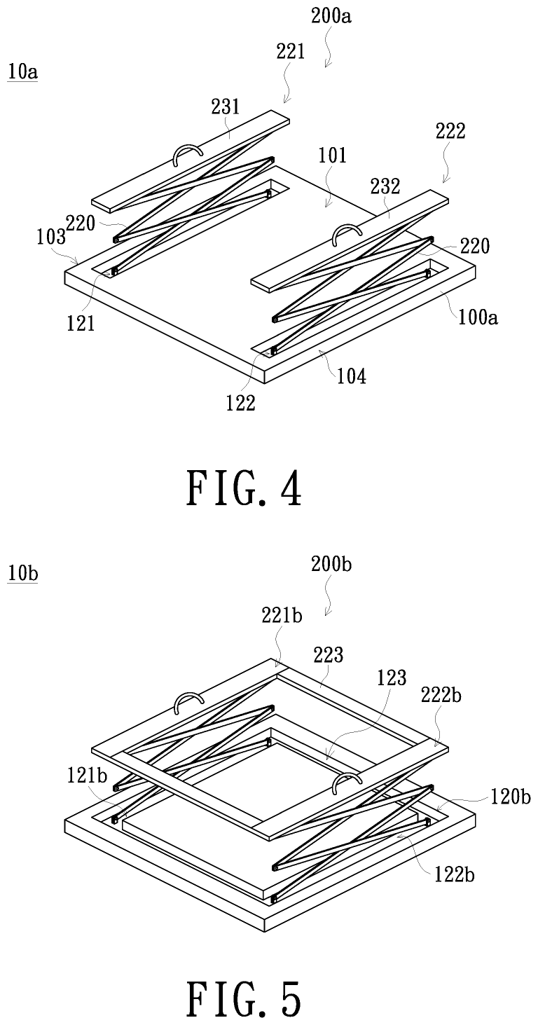

FIG. 4 is a schematic diagram that a telescopic bracket of a motorcycle floor mat extends from a receiving groove according to another embodiment of the present invention. Referring to FIG. 4, a telescopic bracket 200a of a motorcycle floor mat 10a includes, for example, a first telescopic portion 221 and a second telescopic portion 222 arranged opposite to each other, and the receiving groove includes, for example, a first receiving portion 121 and a second receiving portion 122 adapted to receive the first telescopic portion 221 and the second telescopic portion 222, respectively. In addition, the first telescopic portion 221 and the second telescopic portion 222 are, for example, adapted to be stretched separately; in other words, only the first telescopic portion 221 may be extended from the first receiving portion 121 while the second telescopic portion 222 remains received in the second receiving portion 122, and vice versa.

Next, referring to FIG. 1 and FIG. 4, wherein FIG. 4 is a schematic diagram in a direction from a rear 40 of the motorcycle 1 to a front 30 of the motorcycle. In this embodiment, a base 100a has, for example, a first side surface 103 and a second side surface 104 opposite to each other, an extension direction of the first side surface 103 and the second side surface 104 is the direction from the rear 40 of the motorcycle 1 to the front 30 of the motorcycle, and the first telescopic portion 221 and the second telescopic portion 222 are arranged along the first side surface 103 and the second side surface 104, respectively. When the first telescopic portion 221 and the second telescopic portion 222 extend, the item can be blocked by the first telescopic portion 221 or the second telescopic portion 222 to be prevented from falling off the foot pedal 20 of the motorcycle 1. A telescopic bracket 200a in this embodiment has, for example, the first telescopic portion 221 and the second telescopic portion 222, but the quantity of telescopic portions is not specifically limited in the present invention.

In addition, the first telescopic portion 221 in this embodiment includes, for example, a first handle portion 231, and the second telescopic portion 222 further includes, for example, a second handle portion 232. The first handle portion 231 and the second handle portion 232 are, for example, arranged on the first telescopic portion 221 and the second telescopic portion 222, respectively. When the telescopic bracket 200a is received in the first receiving portion 121 and the second receiving portion 122, the first handle portion 231 and the second handle portion 232 are, for example, adjacent to the first surface 101. Specifically, the first telescopic portion 221 and the second telescopic portion 222 are provided with the first handle portion 231 and the second handle portion 232 at one end away from the first receiving portion 121 and one end away from the second receiving portion 122, respectively, allowing the user to easily extend the first telescopic portion 221 and the second telescopic portion 222 from the first receiving portion 121 and the second receiving portion 122. Although both the first telescopic portion 221 and the second telescopic portion 222 extend out in this embodiment, this is not specifically limited in the present invention. In another embodiment of the present invention, the first telescopic portion 221 and the second telescopic portion 222 may be alternatively extended out or received. In addition, the requirement for the first telescopic portion 221 and the second telescopic portion 222 to have the first handle portion 231 and the second handle portion 232, respectively is not specifically limited in the present invention. In another embodiment of the present invention, the first telescopic portion 221 and the second telescopic portion 222 do not have, for example, the first handle portion 231 and the second handle portion 232, respectively. The present invention is not limited thereto.

FIG. 5 is a schematic diagram that a telescopic bracket of a motorcycle floor mat extends from a receiving groove according to another embodiment of the present invention. Referring to FIG. 5, a motorcycle floor mat 10b in this embodiment is similar to the motorcycle floor mat 10a in FIG. 4, and there is a main difference that a telescopic bracket 200b of the motorcycle floor mat 10b in this embodiment further includes, for example, connecting pieces 223 for connecting a first telescopic portion 221b to a second telescopic portion 222b, and a receiving groove 120b further includes, for example, third receiving portions 123 adapted to receive the connecting pieces 223. Specifically, for example, there are two third receiving portions 123 and two connecting pieces 223. Two ends of each connecting piece 223 are connected to the first telescopic portion 221b and the second telescopic portion 222b, respectively, so that when the user stretches or retracts one of the first telescopic portion 221b and the second telescopic portion 222b, the connecting piece 223 may drive the other of the first telescopic portion 221b and the second telescopic portion 222b to be stretched or retracted. In this embodiment, the telescopic bracket 200b has, for example, two connecting pieces 223, but the quantity and shape of connecting pieces 223 are not specifically limited in the present invention. In addition, for example, there are two third receiving portions 123 in this embodiment, but the number of third receiving portions is not specifically limited in the present invention.

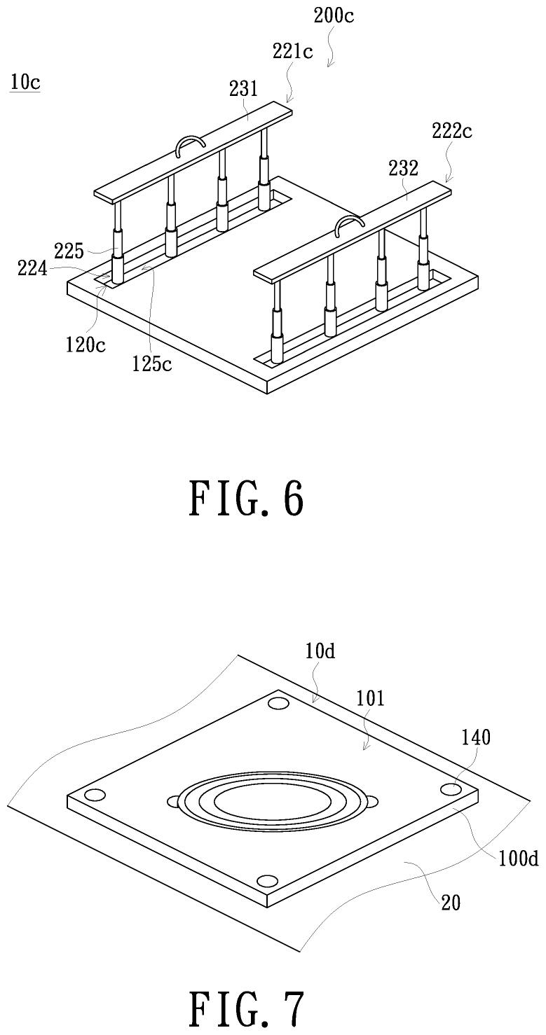

FIG. 6 is a schematic diagram that a telescopic bracket of a motorcycle floor mat extends from a receiving groove according to another embodiment of the present invention. Referring to FIG. 6, a motorcycle floor mat 10c in this embodiment is similar to the motorcycle floor mat 10a in FIG. 4, and there is a main difference that a first telescopic portion 221c and a second telescopic portion 222c of a telescopic bracket 200c of the motorcycle floor mat 10c include multiple telescopic rods 224 respectively. Specifically, the first telescopic portion 221c and the second telescopic portion 222c have, for example, four telescopic rods 224 respectively. When the telescopic bracket 200c extends out, the telescopic rods 224 are sequentially connected by three columnar portions 225, and the closer the columnar portions 225 are to a bottom 125c of a receiving groove 120c, the larger the opening areas of the columnar portions are. Each of the first telescopic portion 221c and the second telescopic portion 222c in this embodiment has, for example, four telescopic rods 224. However, the quantity of telescopic rods 224 of each of the first telescopic portion 221c and the second telescopic portion 222c is not specifically limited in the present invention and does not need to be the same. In addition, in the present invention, the requirement for each telescopic rod 224 to have three columnar portions 225 is not specifically limited, and the requirement for each telescopic rod 224 to have the same number of columnar portions 225 is not further limited. The first telescopic portion 221c and the second telescopic portion 222c of the telescopic bracket 200c in this embodiment have, for example, the first handle portion 231 and the second handle portion 232 respectively, making it easy for the user to extend the four telescopic rods 224 of the first telescopic portion 221 and the four telescopic rods 224 of the second telescopic portion 222 from the receiving groove 120c at a time. However, the requirement for the first handle portion 231 and the second handle portion 232 to be connected to all the telescopic rods 224 of the first telescopic portion 221c and all the telescopic rods 224 of the second telescopic portion 222c, respectively, is not specifically limited in the present invention. In another embodiment of the present invention, each of the first handle portion 231 and the second handle portion 232 has, for example, two handles each connected to two telescopic rods 224, but the present invention is not limited thereto.

FIG. 7 is a schematic diagram of a motorcycle floor mat according to another embodiment of the present invention. A motorcycle floor mat 10d in this embodiment is similar to the motorcycle floor mat 10 in FIG. 3, and there is a main difference that a base 100d in this embodiment has a fixed connection portion 140 adapted to fixedly connect the motorcycle floor mat 10d to the foot pedal 20. A fixed connection method for the fixed connection portion 140 is, for example, screw locking or groove clamping. However, the fixed connection method for the fixed connection portion 140 is not specifically limited in the present invention. In addition, the number of the fixed connection portion 140 in this embodiment is, for example, four and the fixed connection portions are located close to four corners of the base 100d, but the present invention is not limited thereto. In another embodiment, the base 100d may include, for example, two fixed connection portions 140 oppositely arranged on two sides.

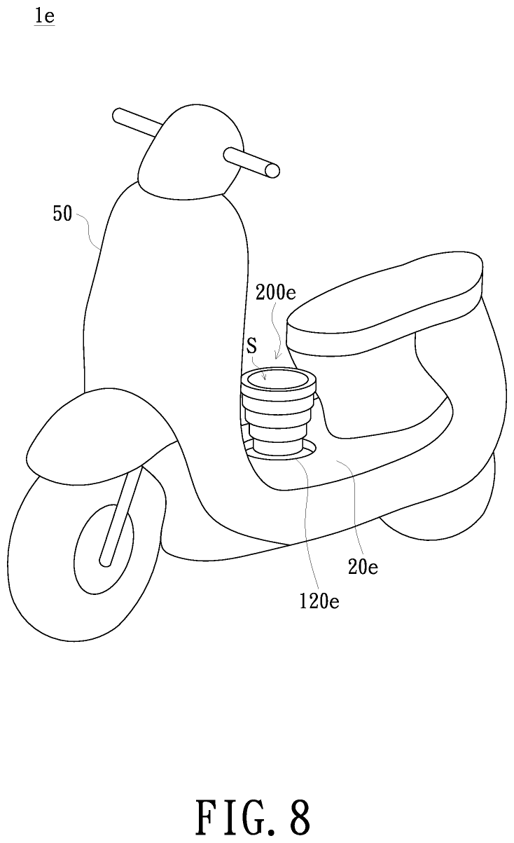

FIG. 8 is a schematic diagram of a motorcycle according to another embodiment of the present invention. Referring to FIG. 8, a motorcycle 1e in this embodiment includes a housing 50 and a telescopic bracket 200e. The housing 50 includes a foot pedal 20e, the foot pedal 20e has a receiving groove 120e, and the telescopic bracket 200e is arranged in the receiving groove 120e and adapted to extend from the receiving groove 120e, to form a storage space S between the telescopic bracket 200e and the foot pedal 20e, wherein the telescopic bracket 200e is, for example, the same as the telescopic bracket 200 in FIG. 2 and will not be repeated herein. In other words, the telescopic bracket 200e of the motorcycle 1e in this embodiment is directly arranged on the foot pedal 20e of the housing 50 of the motorcycle 1e, which is different from that the telescopic bracket 200 is arranged on the foot pedal 20 of the motorcycle 1 by the base 100 in FIG. 1. In addition, the telescopic bracket 200e in this embodiment may be replaced with the telescopic bracket in any other embodiment mentioned above, such as the telescopic bracket 200a, 200b, or 200c.

In summary, the motorcycle floor mat and the motorcycle according to the present invention have the telescopic bracket, so that when the carried item is placed on the foot pedal of the motorcycle, the telescopic bracket may be extended out to prevent the item from falling, and when there is no need to carry the item, the telescopic bracket may be retracted to avoid occupying a foot placement space for a rider.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A motorcycle floor mat, adapted to be placed on a foot pedal of a motorcycle, the motorcycle floor mat comprising:
a base, adapted to be placed on the foot pedal and having a receiving groove; and
a telescopic bracket, arranged in the receiving groove and adapted to extend from the receiving groove, wherein a storage space is formed between the telescopic bracket and the base.

2. The motorcycle floor mat according to claim 1, wherein the base has a first surface and a second surface opposite to each other, the second surface is adapted to be connected to the foot pedal, the receiving groove is arranged on the first surface, and when the telescopic bracket is received in the receiving groove, the telescopic bracket does not protrude from the first surface.

3. The motorcycle floor mat according to claim 2, wherein the base further has a gripping recess arranged on the first surface and adjacent to the receiving groove.

4. The motorcycle floor mat according to claim 1, wherein the telescopic bracket comprises a telescopic cylinder.

5. The motorcycle floor mat according to claim 4, wherein the telescopic cylinder comprises multiple annular portions, the annular portions are sequentially connected when the telescopic cylinder is in an extended state, and the closer the annular portions are to a bottom of the receiving groove, the smaller the opening areas of the annular portions are.

6. The motorcycle floor mat according to claim 1, wherein the telescopic bracket comprises a first telescopic portion and a second telescopic portion arranged opposite to each other, and the receiving groove comprises a first receiving portion and a second receiving portion adapted to receive the first telescopic portion and the second telescopic portion, respectively.

7. The motorcycle floor mat according to claim 6, wherein the base has a first side surface and a second side surface opposite to each other, an extension direction of the first side surface and the second side surface is a direction from a front of a motorcycle to a rear of the motorcycle, and the first telescopic portion and the second telescopic portion are arranged along the first side surface and the second side surface, respectively.

8. The motorcycle floor mat according to claim 7, wherein each of the first telescopic portion and the second telescopic portion comprises a connecting rod mechanism.

9. The motorcycle floor mat according to claim 6, wherein the telescopic bracket further comprises a connecting piece for connecting the first telescopic portion to the second telescopic portion, and the receiving groove further comprises a third receiving portion adapted to receive the connecting piece.

10. The motorcycle floor mat according to claim 6, wherein each of the first telescopic portion and the second telescopic portion comprises multiple telescopic rods.

11. The motorcycle floor mat according to claim 1, wherein the base further has a fixed connection portion adapted to be fixedly connected to the foot pedal.

12. A motorcycle, comprising a housing and a telescopic bracket, wherein the housing comprises a foot pedal, the foot pedal has a receiving groove, and the telescopic bracket is arranged in the receiving groove and adapted to extend from the receiving groove, so as to form a storage space between the telescopic bracket and the foot pedal.
